(19) United States
(12) Patent Application Publication
(10) Pub. No.: US 2003/0009448 A1
(43) Pub. Date: Jan. 9, 2003

(54) Method and apparatus for providing user-specific response

(76) Inventors: Robert C. Covington JR., Smyrna, GA (US); G. Kelly Land, Atlanta, GA (US)

Correspondence Address: KENYON & KENYON, 1500 K STREET, N.W., SUITE 700, WASHINGTON, DC, 20005, US

(21) Appl. No.: 09/879,981

(22) Filed: Jun. 14, 2001

(51) Int. Cl. G06F 7/00

(52) U.S. Cl. 707/3

(57) ABSTRACT

The present invention is directed to a method and apparatus for providing customized responses to user's inquiry by providing a continuously updated database and experts designated to provide a response where the database's responses are insufficient. The present invention is also directed to providing responses in view of a user's profile.

### FIELD OF THIE INVENTION

The present invention is directed to a method and apparatus for providing on-demand responses to subject-specific questions of a known user. Specifically, the invention relates to a method and apparatus for providing an updated database and for providing narrowly tailored responses to Users' inquiries wherein the database is capable of learning response preferences based on the users' previous interactions.

### BACKGROUND

Before the advent of computers there was no efficient way to respond to frequently asked questions in a consistent and efficient manner. Even with the advent of computer and various database search engines, the responses have been limited in scope.

Organizational management requires propagating information from a source to various levels of the organization. Often it is critical to provide uniform responses to the same inquiry posed by different Users or inquiring parties. It is also equally important to provide information which is continuously updated to account for the most recent procedural and legal changes or any other factor affecting the response. Finally, depending on the source of the inquiry, the response may have to be edited in order to be adequate. For example, the response may have to account for the fact that the inquiring party is support staff or a top-level manager. Thus, there is a need to account for the inquirer's profile prior to providing a response.

In responding to this need some organizations designate a person for answering questions relating to each of the many categories of information (e.g., accounting, human resources, legal or technical). Such systems often lack consistency where the designated employee is replaced by a new employee. In addition, the human interface can deter some employees from posing a question deemed to reflect adversely on the inquiring party. Finally, the cost of providing individualized written or verbal response is often high. Crafting a response may require individualized attention by experts who often charge high hourly rates. Repeated responses by these experts to identical or nearly identical questions can be inefficient use of their time. Further, repeated responses by different experts to substantially identical questions also can lead to inconsistent responses.

Another method for responding to this need is to provide an employee handbook which includes answers to most frequently asked questions. This method also suffers from several inadequacies. For example, a list of frequently asked questions often fails to provide an answer specifically tailored to the inquirer's question. In addition, because of the frequent changes in the governing procedures or the law, the handbook must be updated routinely, thereby consuming substantial manpower and increasing cost. Finally, such systems fail to provide live, expert assistance when the database does not contain the relevant information.

Accordingly, there is a need for providing inter-organizational or intra-organizational information to user or inquirers, wherein the information is uniformly updated specifically tailored to the inquirer's situation and takes into account the profile of the inquirer so as to provide the adequate level of information.

### SUMMARY OF THE INVENTION

The present invention is directed to providing narrowly tailored answers to a User's inquiry. In one embodiment, the invention is directed to a method and a system wherein the User's inquiry is addressed from a database of information calculated to provide an adequate response to the User's inquiry taking into account the identity of the inquirer.

In another embodiment, a response to the User's inquiry is forwarded by the system to an expert specifically designated by the user or by the service provider, an entity having authority over User to provide a response to the User's inquiry.

In yet another embodiment, the invention is directed to a method and apparatus for providing a response to a User's inquiry, comprising several databases wherein the databases are continuously updated based on the user's previous inquiries and changes in the legal and procedural matters affecting the response. The databases can be accessed through a network of interconnected computer systems (e.g. internet).

In a method according to one embodiment of the invention, the User submits an inquiry to the system. In response, a system identifies the user and associates the user with a pre-determined profile. Next, the system associates the inquiry with one or more predefined categories and provides one or more possible responses to the inquiry based on the available information in each of the identified categories in the databases. Should the responses fail to satisfy the User, the User is given the option to contact experts and request a response that is narrowly tailored to the inquiry. The system selects one or more Experts on the bases of the User's profile and the nature of the question. The system also considers the nature and the category ascribed to the inquiry and selects Experts accordingly. In addition to directing the expert's response to the User, the system can also add the question and the Expert's response to the existing database in the appropriate category for future applications. Finally, the system can monitor the question and the responses to learn a response selection pattern, thereby updating the likely responses that are to be provided to future users with similar inquiries.

Finally, the present invention provides for a method and apparatus for converting a file having an ASCII compatible format to a web site or a web page compatible format.

### DESCRIPTION OF THE DRAWINGS

FIG. 1 is a process diagram of an embodiment of the present invention for providing a response to a user's inquiry.

FIG. 2 is a process diagram of an embodiment of the invention providing the user with a custom response.

FIG. 3 is a process diagram for updating one or more databases according to one embodiment of the invention.

FIG. 4 is a process diagram of a method for constructing a Web site according to one embodiment of the invention.

### DETAILED DESCRIPTION

I. Search System

At the outset, it should be noted that in the context of this application, the Customer and the User can be two different entities. In one embodiment of the invention, the customer or the subscriber can be any person or entity that subscribes or otherwise purchases access to the system described herein for itself or for a predefined group of Users. The User, or the inquiring party, can be any person who uses the system. For example, a User can be an employee of the customer, and the customer can be the subscribing party. The customer can be subscribing to provide its employees (the Users) the services provided by the search system. Thus, the employer (subscriber) can not only identify the employees (Users) having authority to access the system, but it can also decide whether to limit the individual user's access in any manner.

Upon entering the system the User can be identified through its association with the subscriber and can be provided access to the system's services on the basis of its profile. Should the subscriber wish to limit the User's access to certain areas, the User's profile can be adapted to reflect the limitations and the User would have limited access to the system accordingly.

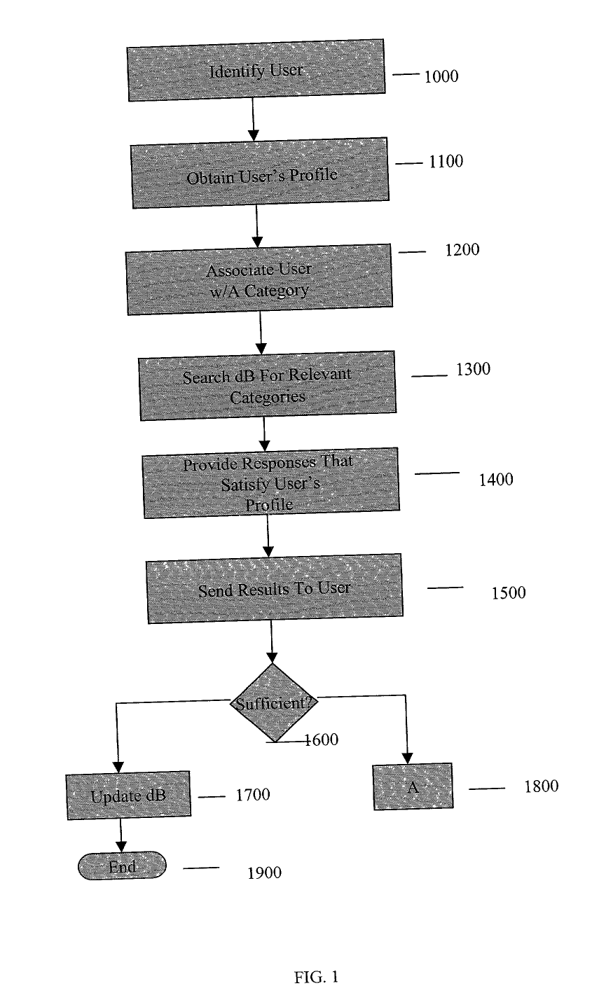

FIG. 1 is a process diagram of an embodiment of the present invention for providing a response to a User's inquiry. Referring to the embodiment of FIG. 1, the process starts with step 1000 where the system identifies the User as the inquiring party. The identification step can be accomplished through a number of conventional methods. For example, the User can log on to the system by entering a password and a name.

In step 1100, the system would retrieve the User's profile from a database. The profile can contain information concerning the User, for example, the subscriber associated with the User, the User's name and title and any search limitations that the subscriber may have imposed on the User. For example, the subscriber may have only purchased access to the technical database for the User. Based on the profile, the system can determine how to treat the User's inquiry.

The User's profile can also be arranged to direct all inquiries from the User to an expert. The Expert can be associated with the service provider, the customer a third party (e.g., person or entity). In an embodiment where the expert is associated with the User, the expert can be the payroll manager for the User's company. In this manner any question the user may have relating to the User's 401(k) Plan account (“401(k) Plan”) that is not answered by the database would be automatically directed by the system to the payroll manger. In an embodiment where the expert is employed by the service provider or a third party, the system can act in a similar manner except that the inquiry can be routed to a service provider's expert or the third party expert. In the pending hypothetical, the expert can be an accountant having expertise concerning payroll and 401(k) Plan.

Referring to FIG. 1, after reviewing the user's profile in step 1300 the system searches the available databases for categories identified in step 1200. In step 1300 the system must also exercise judgment to (i) narrow the field of information to what is considered to be the most relevant information, and (ii) narrow the field of search to suit the User's profile.

Once potential responses to User's inquiry have been identified, the system, in step 1500, notifies the user of the selection of potential relevant information (hereinafter “information records”). In one embodiment of the invention the system can provide the user with a Web page containing a brief abstract of each piece of relevant information record and providing a hypertext link to each record. In another embodiment of the invention the system can provide a brief abstract of each information record along with an estimated likelihood that the information record an is relevant to the inquiry. In steps 1400 and 1500, the system sends the results to the User.

In step 1600, the system inquires whether the responses provided in step 1500 were sufficient to the User. If the User's reply is positive, the system updates its database to record the inquiry, the inquiring party, the provided responses and the User's reply, if any. The system may also record additional information such as whether the User reviewed any of the several potential answers or whether the User simply logged off after seeing the results. In this manner the system can learn from its interactions with the Users and adapts its future responses accordingly.

In one embodiment of the invention, a log of all questions asked by a particular user and the user's selected history (“click history”) showing the features of system they have accessed previously can be compiled by the system. The click history can be stored in a database for future reference. The database can provide information concerning the questions asked and the click history, among others, so that when the User inquires about the same subject in future only new responses would be presented. Thus, when the User inquires about the same subject in future the system would deliver to the User only the responses that the User considered to be relevant. At the user's request, the system can also provide information already viewed by the user. This step of updating the database is identified as 1700 in FIG. 1. If the responses here found by User to be satisfactory, at step 1900 the process ends.

Updating the database provides several other advantages. For example, through repeat use, the system can identify which of the many answers to the same question is discarded by users. Given this pattern, the system can excluded any discarded answer from future responses. Analogously, if the User's reaction to a particular search shows that the User exits the system after viewing the choice of responses, the system can conclude that the responses are inadequate and proceed to drafting new responses to the particular inquiry. For example, consider a situation where a users inquiries the system for information relating to a 401(k) Plan, reviews the information provided and logs off the system. On a subsequent occasion the same User searches the system for information relating to a 401(k) Plan. The system having access to the User's previous search history can eliminate the responses already provided to the user and present a new set of response, thereby avoiding repetition.

In another example, a database of a User's past inquiries and responses can be used to better serve other users. Thus, if the system learns through repetition that users most often view responses relating to a 401(k) Plan as summarized in articles X, Y and Z, the system can adapt itself to provide articles X, Y and Z at the top of the list to all future inquiries relating to 401(k) Plan.

The Users of the database or the customers of the service can also initiate a process to update the database. For example, if a User is unable to find relevant information in step 1400, or if the User is simply unable to find the requested information readily, the user can contact the Database Manager and request that the database be updated to improve the search.

Returning to FIG. 1, if after viewing the potential responses to the inquiry, the user is still not satisfied, the User can request a custom response by an Expert. This is represented as step 1600. On its own initiative, the system can also consider providing at least one additional response in the form of a custom response by sending a request to an Expert. This is represented in step 1800.

As briefly discussed, the Expert (or Subject Matter Expert) is anyone selected to be a member of the Service Provider's database management team. Such an expert can be a person designated by either the customer or by the service provider. Such an expert can also be an independent contractor or a consultant, or other experts with whom the customer may contract for creating additional information for existing or new databases. Thus, in one embodiment, the customer can designate an existing employee as the expert. In this embodiment, any particular set of categorized inquiries that are not satisfied by the process outlined in FIG. 1, would be directed by the system to the Expert. In addition, the customer can specify that certain User's questions should be answered only by the Expert. In this manner the User's inquiry will be automatically directed to the designated expert. With reference to FIG. 1, upon performing steps 1100 and 1200, the system would skip the interim steps and more directly to step 1800.

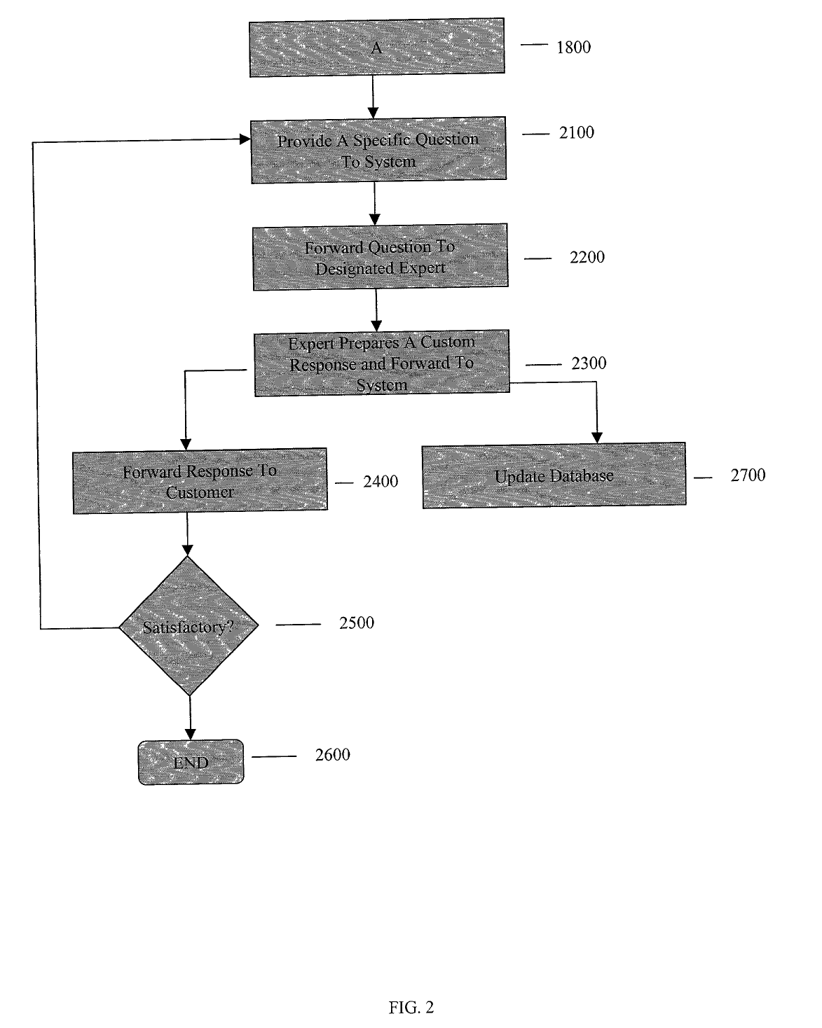

FIG. 2 is a process diagram of an embodiment of the invention providing the user with a custom response. Referring to FIG. 2, the User of the process in FIG. 1 after viewing the response, requests additional information. The User is asked by the system to provide a description of the information that the user needs. In this step the inquiry can be presented in the natural language form, or any other suitable form calculated to solicit the desired response. For example, the User can pose a question in any manner she wishes and add as much detailed information as she deems appropriate.

Returning to the 401(k) Plan hypothetical, the user can pose a formal inquiry by asking: “Having worked for a previous employer who had a 401(k) Plan, can I roll over the previous 401(k) Plan into my present employer's 401(k) Plan without incurring any tax consequences?” It can be seen that the user's inquiry is specifically tailored to her instant situation. Thus, the Expert's response would be a direct response to the User's question and would address the user's specific predicament.

Thus, in step 2100 the user provides the system with her specific inquiry (“custom inquiry”). As discussed, the custom inquiry could contain comprehensive detail to inform the Expert of the precise nature of question. In one embodiment of the invention, the User can email her inquiry in natural language to the system. In another embodiment of the invention the User can forward a voice message of her inquiry.

Upon receiving the customer inquiry, in step 2200, the system forwards the inquiry to the designated Expert. Forwarding the custom inquiry to the Expert could entail, for example, forwarding only the text of the question to the expert or it could entail identifying the inquiring party. In either event the customer can decide whether identities of its Users would be disclosed to the Expert or whether the User would remain anonymous. The customer's preference would be recorded in a database containing the customer's profile and the User's profile. In this manner and upon the User's request, the system would not disclosed keep the User's identity to the Expert. As stated, the User Profile or the Customer profile can include this information.

The Expert responds in step 2300 to the User's inquiry by forwarding a response to the system. The expert's response is forwarded to the User in step 2400. Should the User find the response satisfactory, the process ends at step 2600. However, should the User find the response insufficient or should the User have additional questions, step 2500 would direct the system to repeat steps 2100 to 2500.

As stated, the customer can elect the expert to be provided by the service provider itself. In this embodiment, User's inquiry can be routed to the a Database Manager, described below, which will prepare a response to the User's custom inquiry and forward the response to the system, which in turn, can forward the response to the user.

II. Database Management

In providing the desired information to the user, the present invention not only provides a fast and effective method for providing narrowly tailored response to user's inquiry, but also the system maintains updated databases for future inquiries. For example, in the embodiment of FIG. 2, the system uses the expert's response to update the corresponding databases by forwarding the expert's response to a Database Manger in step 2700.

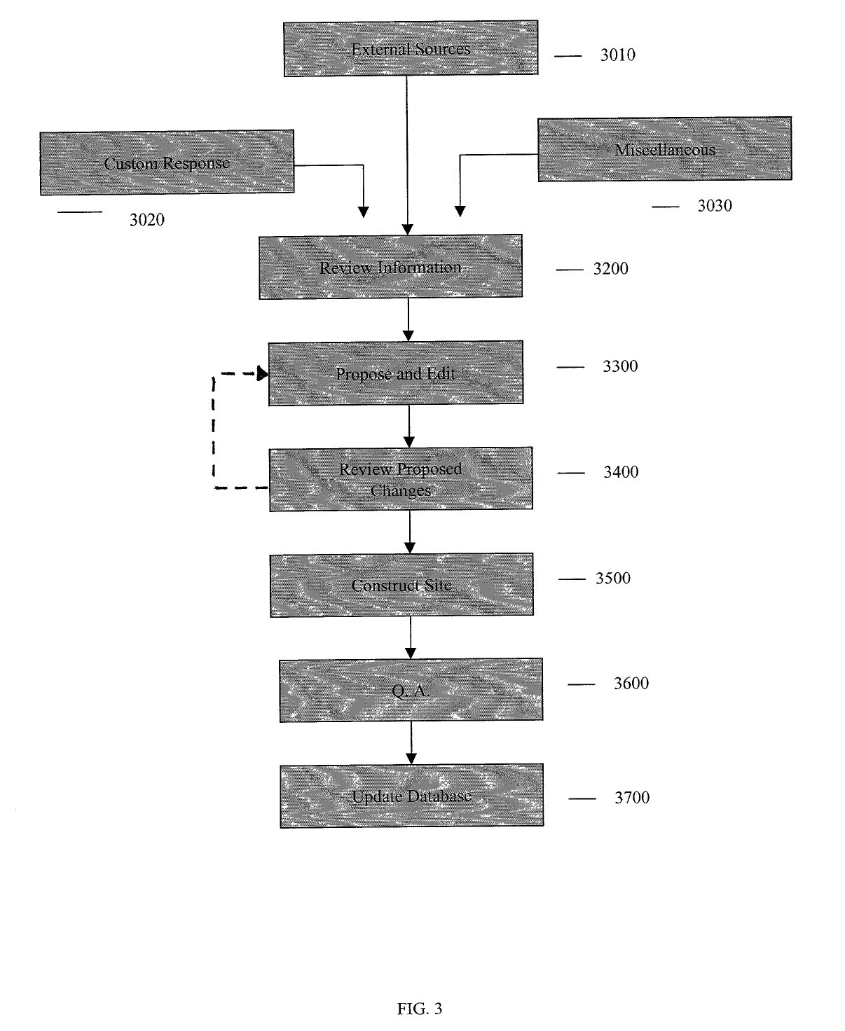

FIG. 3 is a process diagram for updating one or more databases according to one embodiment of the invention. In updating the databases, responses are first reviewed by a Database Manager. A Database Manager can be a person or a team of persons that create and/or aggregate information relating to the services provided by the system. In one embodiment, the Database Manager can include all of the subject matter experts responsible for creating foundation information. Foundation information can be a core foundation of information that has general applicability. Such information can include, information applicable to all customers dealing with a specific category of information. For example, in the area of 401(k) Foundation information can be basic definitions that apply equally to any 401(k) plan.

The members of the database management team may include, employees of the service provider, independent contractors or consultants or outside companies contracted by the service provider to provide specialized information in a field of interest to the service provider. Database Managers, for example, can be accountants, attorneys and persons with expertise in technology, business or management. Accordingly, Database Management team members can be selected based on their expertise in a related field.

Referring to FIG. 3, Database Manager receives information from at least three different sources (step 3200). Custom responses 3020 can be similar to those described above (i.e., step 2300 of FIG. 2). That is, custom responses prepared by the Expert are also forwarded to Database Managers who uses this information to update the database.

In addition to custom responses, Database Managers can have access to external sources of information or external information providers. External sources, as illustrated in FIG. 3 as 3100, can be entities that are engaged in the business of gathering and reporting information on one or a plurality of specific topics. For example, the Bureau of National Affairs (“BNA) and the Institute of Electrical and Electronic Engineers (“IEEE”) are entities, which as part of their course of business, report on information with respect to which they have certain expertise. BNA, for example, reports on various topics including, federal and state law such as human resources, taxation, estate planning, environmental regulations, etc. Thus, in one embodiment of the invention, the system makes available to the Database Mangers the most recent updates relating to a particular subject matter provided by such an external source of information.

Miscellaneous sources of information (3030) can include the customer itself, or any person or entity, that provides information, whether employed by the service provider. In step 3200, the information is reviewed by Database Managers and evaluated before they use it to update the database.

Once Database Managers have determined that the database is to be updated to reflect the newly-received information, one of several alternatives can occur. In one embodiment, Database Managers can review the existing information in the database and decide to add the information to the already-existing information in the database. In this embodiment, the information in the database is updated to include the new information. In another embodiment, after reviewing the existing information, the Database Manager can decide to replace the existing information with new information. In this embodiment, the Database Manager can update the database by removing the out-dated information and replacing it with new data. In a further embodiment, the Database Manager may determine that the information in the database should be revised in parts to reflect the certain changes in the existing information. In this embodiment, the Database Manager can take the necessary steps to revise the available information accordingly. In yet another embodiment, the Database Managers may elect to include the new information in a new database. Thus, the Database Manager must establish the parameters for the new database, add or define new categories and structure for the database.

In an embodiment where the databases are accessible through the Internet, the data can be presented in the form of a Web page a Web site. In this embodiment, a dedicated server can deliver the information as Web pages accessible by the user. In this embodiment, the Database Manager can, either directly or through an agent or software, prepare a Web site containing the relevant information and post the Web site in the database enabling User's access.

Should Database Manager determines that, in view of the new conditions (e.g., receiving updated information, custom information or user feed back) the database should be edited, in step 3300 the Database Manager prepares the information with the suitable content. In step 3400, the information is forwarded to Database Reviewer who can review the information mostly for format or other non-substantive attributes. Should the proposed information fail to satisfy formal requirements, the Database Manager can either revise the proposed information or return the same to the Database Manager for revision. This is reflected by the broken line between steps 3400 and 3300.

In one embodiment of the invention, Database Reviewer adds additional categories and structure to the proposed database prior to adding the new information to the database. The system provider can also add categories to the system so that new and existing information can be organized for better retrieval. A Database Manager can then categorize any information, new or old. Categorization enables a User to retrieve the information from the database once it is added to the database. For example, if the subject matter of the information received from Database Manager in step 3200 concerns the subject of sexual harassment under state and federal statute, the Database Reviewer may categorize the information in such manner that any search term concerning sexual harassment would yield the newly created information. The Database Reviewer can also provide additional information which would correlate the record with other pertinent records. For example, the Database Reviewer or the Database Manager can identify similarly categorized or otherwise related information records that may be of interest to the User based on the User's inquiry. Accordingly, such techniques as cross referencing other information records or providing hypertext links to other information records can be used to advise the User of additional information.

In the example of Sexual Harassment, a User reviewing information relating to Sexual Harassment can access other information records by activating a hypertext link which can direct the User to an information record defining a particular state's law on sexual harassment.

In one embodiment of the invention, the Database Reviewer continuously reviews the Users' sessions to determine whether the Users find relevant information or whether they failed and either terminated the session or opted to ask for additional information. For example, Database Reviewer may learn that, in response to a search designed to retrieve information about sexual harassment, nine out of ten Users, after being informed of available information, did not review any of the information provided and chose to terminate the session, while only one User went on to ask for additional information or more detailed information. A Database Manager may construe this pattern as an indication that the information provided by the system in response to this search was inadequate to properly respond to the User's inquiry. The Database Manager can then revise the categories applied to the information in the database and structure the information in the database such that future users having similar inquiries would be provided with a different search result better suited to their inquiry. In the vernacular of this example, Database Reviewer can review the available information relating to sexual harassment and organize the database so that other information more closely directed to responding to the user's inquiry would appear as the first set of response to the user's inquiry.

The Database Reviewer can also add additional structure to the information provided by Database Manager in step 3300. The structure can be any attribute that would make the information readily discernable.

In an embodiment of the invention where the system is accessed through the Internet the information is provided to the User as Web pages. To implement such an embodiment, the information prepared by the Database Manager (step 3300) and reviewed by the Database Reviewer (step 3400) is then formed into a Web page accessible to the User. This step is represented as step 3500 in FIG. 3 and will be described in greater derail below.

Step 3600 of FIG. 3 is directed to Quality Assurance. By this point in the process, a Web page containing the information has been produced having the look, feel and functionality of the service provider's Web Site. The Web page is now in Web Format ready for final review before publication to a live Web site. In step 3600 the Quality Assurance Team reviews the Web Pages for accuracy and to ensure the desired quality. The Quality Assurance team can include members of the service provider's staff, an expert (from the service provider, from the customer or from any third party), a staff member of an external information source provider, technology staff (from the service provider, from the customer or from any third party). Finally, upon approval by the Quality Assurance Team, in step 3700, the web page can be added to the database.

While the embodiments presented herein are directed to providing a service over the Internet, it is understood that the invention is not limited thereto. An ordinary skill artisan would recognize that the invention contemplated herein can be implemented in a variety of forms, these forms being within the scope of this invention to the extent that they deliver desired information to a User of the service according to the methods contemplated herein.

III. Site Constructor

As discussed in reference to FIG. 3, in one embodiment of the invention, information is presented to the User through the Internet with each response, or information record, being encapsulated in a Web page. In this and similar situations, once the information record is created, for example in a conventional data processing format, the information record may be converted to a Web page by using a Site Constructor.

The Site Constructor process applies a special template to an information record, which can be in any word processing format. Although word processing documents are conventional, the record information can also be in an ASCII-compatible format. In one embodiment of the invention, a template prompts the user for basic header and summary information relating to the document. The template can be constructed to allow the user to type the body of the document with the layout in which the document should appear on the Web. Alternatively, the template can allow the user to cut and paste the information record in the desired layout. Next, the template will place the appropriate HTML tags or codes into the document. The author and/or the Database Reviewer in one embodiment, can then view the document as it will eventually appear on the Web. The document must also be saved onto a version-controlled database so that the version control database can track future changes.

The next steps provide a tool for the Site Administrator to get the document ready for publishing to the Web. Site Constructor allows the Site Administrator to apply an HTML to XML conversion process and an XML to ASP conversion process. This conversion process takes the word processing document (or information record) with embedded HTML tags and applies a designated set of XSL Style sheets and support files to transform the document into an ASP file format that conforms to the Web site's specifications making it ready for publishing. The XSL Style sheets and support files relate to navigation, related links (embedded as hypertext link), appearance and functionality (look and feel or layout characteristics), etc. Application developers can create the style sheets and support files as is known to one of ordinary skill in the art. Application Developers can also maintain the style sheets and support files separately from the converted document. Site Constructor then combines these style sheets and support files (step 4500) with the content in the document template to produce the final pages for the Web site.

It will be noted that this process greatly simplifies the Web publishing process. This process allows the authors of the content and the Application Developers to concentrate on their respective areas of expertise. The authors of the content, for example Database Managers, can focus on subject matter requirements or gathering proper information from the experts and updating the existing databases. The Application Developers, on the other hand, can concentrate their efforts on creating the overall appearance and functionality of the Web site. The Application Developers can use an automated process to merge the content and the appearance and functionality of the Web site with little effort.

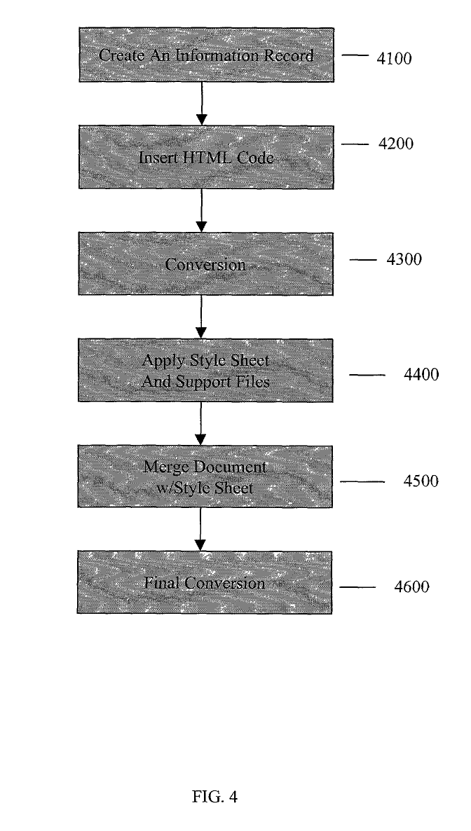

FIG. 4 is a process diagram of a method for constructing a Web site according to one embodiment of the invention. Referring to FIG. 4, in step 4100 a data record of the information is created. As stated, the information can be created by the Database Manager as a written document and forwarded to Database Reviewer. The Database Reviewer can review the data record document for formal accuracy and for adding other structural attributes described above (i.e., category identification or link to related documents).

In one embodiment of the invention, the document can be created in a conventional word processing format such as Microsoft Word®. The author of the data record with basic word processing skills and little or no Web experience can create a document in this format using the Site Constructor Word Template. In one embodiment of the invention, Site Constructor installs this template on the author's workstation or computer and provides the author with a form to complete that includes basic information about the document. The author can be, for example, the Database Manager. The template prompts the author for information regarding: the title (document title, short title, document filename), name or names of the author, sources of information, document summary or abstract, related content, document keywords to assist the system in identifying the document for future searches, and the subject expiration date, if any. In this context, related content can be an area where the author keeps notes on other sections of the website which are relevant to the document or the topic. The information presented above, including the document keywords, are of special importance for the search process outlined above.

After completing the template form, the author can create the document by typing in the information record. In one embodiment, using simple pre-defined macro functions in the toolbar, the author can simply type the document with the layout in which they want it to appear on the Web.

Authors can also incorporate pre-existing documents into the Site Constructor Word Template. The author can open the pre-existing document using the Template. The author must then fill in the appropriate fields on the form, save the document in the version control database, and continue with the rest of the Site Constructor process.

After completing the document using Site Constructor, including any necessary editing and revising, the author then saves the document to the version-controlled database for future change tracking. In step 4200, and as the author saves the document, the Site Constructor Template combines the information entered in the initial form and the HTML formatting tags to create a document with all the necessary HTML code embedded in the document.

At this point, the author can use Site Constructor Template viewer to see the document as it will appear on the Web or make any additional modifications. The author then must save the document in the version control database. In one embodiment of the invention, only updates that have been made are saved, enabling the Users to track the changes in each save-process.

In step 4300 the word processing document embedded with HTML tags is converted to the XML format. In one embodiment, Site Administrator can perform this function. In such embodiment, the Administrator uses the Site Constructor interface to retrieve one or more documents from the version-control database. The Site Constructor application can have graphic user interface such that the Administrator can see the status of the various steps in the process.

Site Constructor then uses a conversion process that reads through each document and converts into XML the information from the form in the Site Constructor Template and all of the embedded HTML code. These steps allow the Site Administrator to merge the document with various style sheets and include files (otherwise known as support files) so that Site Constructor can transform the look and feel characteristics of the document to match those of the Web site of the service provider (step 4500).

Site Constructor can be run as a complete process or can be stopped at this phase to create XML documents. This is particularly valuable in situations where XML content is being exported to third party Web sites. Each external site can then apply its own set of styles and support files to alter the look and feel characteristics of the documents in order to fit the particular look and feel characteristics of its desired Web site.

In addition to the creation of the content document and the corresponding XML file, application developers and graphics designers can create the necessary programming (step 4410) and Look and Feel characteristics or the layout (step 4420) required to complete the web page.

In step 4410, the Application Developers create files that contain all the web site's functionality. This functionality can be for either server-side processing or client-side processing. These files contain functionality such as: determining user permissions to view a page, making calls to databases to retrieve and store information, determine special user based customization of the web page, and any other functionality the page may contain. This is stored in separate files.

In step 4420, the Graphics Designers can layout and create the necessary files to define the web site's look and feel characteristics. The Graphics Designers create all the necessary images and define the template to determine, fonts, colors, sizing, and positioning of all the items on the web page. These files and layout instructions are then referenced by the XSL Style sheets as Site Constructor is building the ASP web page.

In step 4430, the XSL Style Sheets are created to incorporate the support files and the look and feel characteristics of a Web site into the existing document. These style sheets combine the support files and code and the look and feel characteristics to form a map for Site Constructor to follow when converting the information document into the final web page. The XSL style sheet can perform three main tasks:

1. Generates HTML Code: This step in the process creates all the additional codes, such as table definitions, page sizing, graphic locations, and text positioning, that are not already contained in the Site Constructor. Templates are necessary to incorporate the Web site's look and feel characteristics. Site Constructor adds any special formatting, coloring, and graphics to the document so that it conforms to the rest of the Web site.

2. Incorporates Support Files: Support files (otherwise known as “include files”) contain almost any functionality that can be used in a Server Side Web page, such as additional HTML, navigation, image references, Visual Basic (VB) scripting, Java scripting. Site Constructor utilizes the style sheet to determine the type of document it is modifying and to insert the necessary support files that are necessary for that document type. Examples of these types of support files are navigational functionality, determining user permissions, activity logging information, and special user based customizations. The support files can be another document or object that is inserted. Support files can be navigation (top and left navs.), special programming code to perform functions such as granting permission to the page, logging usage, determining the type of browser, applying common graphics such as a company logo. This can also be the basis of also the functionality used to convert any document into a web page. In one embodiment of the invention, Site Constructor reads the type of file under process (a database inquiry, for example) and determines from the XSL style sheet what specific guidelines need to be implemented to format the page.

3. Run Specific Functions: The XSL style sheets also have the ability to run their own functions. Common examples include creating a left navigation bar, creating titles for the files, determining the need for (and then creating) “Next” and “Previous” buttons at the bottom of a Web page and the associated hyperlinks. If a Web site uses such functions, Site Constructor can add them from the style sheets.

Thus, the XSL style sheets and support files enable various Site Developers to separate the Web development and content creation aspects of Web site development, thereby enabling the content developer (e.g., Database Manger or Database Reviewer) to work independently of the Site Developers. The Site Developers can store the look and feel characteristics of the Web site in only a few files and Site Constructor can automatically apply these characteristics to the entire Web site.

These steps, 4100 through 4430, present the core advantage of Site Constructor. These steps enable the content creation and web development efforts to be separated. As a result, the Database Managers can concentrate on their areas of expertise and create the appropriate content and do not have to be experienced Application Developers. In conjunction, the Application Developers can create a web site without needing the necessary content in advance. Both groups can develop simultaneously and independently and have their efforts combined through the automated Site Constructor tool as described in step 4500.

Site Constructor can be flexible and can be programmed to recognize a specific set of files and apply a distinct look and feel and formatting to the set of files. The XSL files may look for different variables from the Site Constructor Word Template and can then process the files differently depending on the variables.

Returning to FIG. 4, step 4500 includes one core functionality of the Site Constructor process. In step 4500, the Site Administrator uses the Site Constructor interface to apply the appropriate XSL Style sheet to each document, which is now in XML format. The XSL Style Sheet provides a map to tell Site Constructor how to read through the XML document and what functions to perform throughout the document. The Site Constructor can be made to process the XML to determining the appropriate support files that need to be incorporated. As the support files are incorporated, Site Constructor can insert the relevant code into each XML document. The end result is a complete XML document that conforms to the rest of the Web site.

In the step 4600, Site Constructor saves the XML document as an ASP document. Site Constructor can then save the ASP document to a designated directory or a location where it is stored until it tested. Thereafter the ASP document can be published on the Web site. This can be the version of the file that is published as a web page.

Upon completion of the conversion processes, the Site Constructor can purge from the memory all documents created by the interim processes leaving only the original document and the final ASP file. Site Constructor can perform all interim processes by using system memory rather than by creating a set of temporary files. This process can maximize the performance of the Site Constructor process.

Although the Site Constructor has been presented in association with the embodiments of the services provider of the present invention, it should not be limited to applications thereto. Rather, the Site Constructor is contemplated to have utility in any conversion process wherein an ASCII file is converted into a Web page or a Web site. Further, it should be noted that, although the database search system of the claimed invention is exemplified through embodiments relating to corporate management, accounting and information systems, the invention should not be construed as being limited thereto. The method and apparatus presented herein can be applied to any subject matter and any search intended to provide the user with narrowly tailored results. Such searches can include, for example, a search of legal, medical, technical or non-topic specific searches.

1. A method for providing information in response to an inquiry submitted by a User, the method comprising:
identifying the User by associating the user with a predefined profile;
identifying a first search parameter based on the inquiry;
formulating a search parameter based on the user's profile and the first search parameter;
searching a first database for a first record relating the first search parameter; and
providing the user with the first record.
